(19) United States
(12) Patent Application Publication
(10) Pub. No.: US 2026/0342475 A1
(43) Pub. Date: Oct. 29, 2026

(54) METHOD AND SYSTEM FOR DECODING ERROR-CORRECTING CODES

(71) Applicant: THE REGENTS OF THE UNIVERSITY OF CALIFORNIA, Oakland, CA (US)

(72) Inventors: Jiun-Ting HUANG, La Jolla, CA (US); Young-Han KIM, La Jolla, CA (US)

(21) Appl. No.: 19/485,937

(22) PCT Filed: Jun. 17, 2024
(86) PCT No.: PCT/US2024/034291

§ 371 Date: Nov. 19, 2025

Related U.S. Application Data
(60) Provisional application No. 63/508,562, filed on Jun. 16, 2023.

(51) Int. Cl. H04L 1/00; G06N 7/01

(52) U.S. Cl. CPC H04L 1/005; G06N 7/01

(57) ABSTRACT

A receiver for receiving a signal over a communication channel includes a channel estimator, a demodulator, a channel decoder and a source decoder. The channel estimator is configured to receive the signal and estimate channel parameters. The demodulator is configured to demodulate the received signal and estimate transmitted bit sequences based on the channel parameters provided by the channel estimator. The channel decoder is configured to decode the bit sequences received from the demodulator to recover transmitted codewords based on the channel parameters using parallel Monte Carlo Markov Chain (MCMC) decoding. The source decoder is configured to convert the decoded bit sequence output received from the channel decoder into a signal having data that is in a format that is the same as data in the signal transmitted over the communication channel.

### CROSS REFERENCE TO RELATED APPLICATION

This application claims the benefit of U.S. Provisional Application Ser. No. 63/508,562, filed Jun. 16, 2023, entitled “SYSTEMS AND METHODS FOR DECODING ERROR-CORRECTING CODES”, the contents of which are incorporated herein by reference.

### BACKGROUND

Linear block codes are used in forward error correction and are applied in methods for transmitting symbols (e.g., bits) on a communications channel so that, if errors occur in the communication, some errors can be corrected or detected by the recipient of a message block.

An example of a decoder for linear block codes in the context of Monte Carlo Markov chain (MCMC) decoders is shown in A. Bhatt, J.-T. Huang, Y.-H. Kim, J. J. Ryu, and P. Sen, “Monte Carlo methods for randomized likelihood decoding,” in 2018 56th Annual Allerton Conference on Communication, Control, and Computing (Allerton). IEEE, 2018, pp. 204-211. The MCMC decoding algorithms presented in this reference can efficiently decode linear block codes of dimension 40 and lower. However, due to their high time complexity, those decoders cannot deal with codes of dimension over 100.

Another example of a decoder for linear block codes in the context of decoding Reed-Muller codes: is shown in M. Ye and E. Abbe, “Recursive projection-aggregation decoding of Reed-Muller codes,” IEEE Transactions on Information Theory, vol. 66, no. 8, pp. 4948-4965, 2020. Simulation results show that the recursive projection-aggregation algorithm in this reference does not achieve the optimal block error rate.

Yet another example of a decoder for linear block codes in the context of near-optimal decoding of general linear codes is shown in K. R. Duffy, L. Jiange, and M. Médard, “Capacity-achieving guessing random additive noise decoding.” IEEE Transactions on Information Theory vol. 65, no. 7, pp. 4023-4040, 2019. Theoretical analysis indicates that the decoding algorithm proposed in this reference processes a high asymptotic complexity, which may become prohibitive when the algorithm is applied to decode linear block codes of dimension over 100.

Consider the decoding problem for binary linear block codes. A codeword X is uniformly and randomly selected from a codebook C∈

$${𝔽}_{2}^{n}$$

of dimension k. The selected codeword X is then transmitted through a memoryless channel characterized by a conditional distribution p(y|x). Given the received bit sequence Y, the receiver wishes to reconstruct the transmitted codeword X. The performance of a decoding function (possibly randomized)

$$\hat{X} : {𝔽}_{2}^{n} \to C$$

is evaluated by the probability of decoding error

pₑ=P(X≠\hat{X}(Y)). (1)

Choosing the codeword which maximizes the posterior probability p(x|Y) is known as maximum a posteriori (MAP) decoding, which can be expressed equivalently as the maximum likelihood (ML) decoding under the assumption of a uniform prior

$${\hat{X}}_{M L} ( Y ) = {arg max}_{x ∈ C} p ( Y \vert x ) = {arg max}_{x ∈ C} p ( x \vert Y ) \qquad ( 2 )$$

and this minimizes the probability of decoding error. However, the problem of optimal decoding of a general linear code is known to be NP complete.

Instead of solving the discrete optimization problem (2), the randomized likelihood (RL) decoding algorithm generates the estimate by taking a sample from the posterior

\hat{X}_{RL}(Y)~p(x|Y)∝p(Y|x). (3)

Although being a randomized algorithm, the RL decoding has been proven to have near-optimal performance. The probability of error of the RL estimate in (3) is upper bounded by twice of the best achievable value from the ML decoding rule

P(X≠\hat{X}_{RL}(Y))≤2P(X≠\hat{X}_{ML}(Y)), (4)

which is a result of the Liu-Cuff-Verdú (LCV) lemma. Nevertheless, from a complexity perspective the RL decoder does not serve as a less onerous solution for near-optimal decoding because the exact sampling from the posterior requires the computation of the partition function Σ_{x∈C}p(x|Y) for normalization.

In 2001, Neal pioneered in the development of practically implementable approximate RL decoding algorithms using the MCMC sampling method in R. M. Neal, “Monte Carlo decoding of LDPC codes,” Dept. of Computer Science, University of Toronto, Tech. Rep., 2001, presented at ICTP Works. Statis. Phys. Capacity-Approaching Codes.

The MCMC decoding algorithm is a class of randomized graphical algorithms that construct a graph G on the codeword set C (or the entire space

$${𝔽}_{2}^{n} ) ,$$

run a Markov chain

$${\{ {X}^{( t )} \}}_{t = 0}^{∞}$$

on G with a stationary distribution equal to the posterior p(x|Y) (or p(x|Y)1_{C}(x) if the state space is

$${𝔽}_{2}^{n} ) ,$$

and generate an estimate after sufficiently many iterations. There are two key features of the MCMC sampling method:
(1) there exist simple MCMC algorithms, for example, the Gibbs sampling, also known as the Glauber dynamics, where each Markov chain transition only relies on computing the stationary probabilities of the neighboring nodes up to a multiplicative constant (see S. Geman and D. Geman, “Stochastic relaxation, Gibbs distributions, and the Bayesian restoration of images,” IEEE Transactions on pattern analysis and machine intelligence, no. 6, pp. 721-741, 1984).
(2) it is possible that the number of iterations required for a Markov chain to reach the mixing time be far less than the size of the state space (see D. A. Levin and Y. Peres, Markov chains and mixing times. American Mathematical Soc., 2017, vol. 107).

Predicting the precise Markov chain mixing time is a difficult problem, and most of the theoretical results giving upper bounds on the convergence time are of little practical use. Therefore, the efficiency of MCMC decoders was primarily studied through numerical simulations. Existing simulation results for randomly generated (40,20) low density parity check (LDPC) codes over binary symmetric channels (BSCs) demonstrated that an MCMC decoder based on block Gibbs sampling and block updates can achieve twice of the ML error probability with a reasonable number of iterations. The convergence speed of the block Gibbs decoder, however, still becomes prohibitively slow for larger codes.

### SUMMARY

In one aspect, the present disclosure provides a method and system of fast-converging MCMC decoding for linear codes transmitted over memoryless channels. The decoder generates a small number of candidate estimates by simulating multiple Markov chains in parallel on the codebook, and performs an ML decoding among the candidates. One important aspect of the method involves the transformation of the generator matrix of the linear code into different systematic forms to construct distinct Markov chains for decoding.

To demonstrate the practical feasibility of the decoder described herein, its performance is evaluated for Reed-Muller codes of length 64 and 128, including RM(2,6), RM(3,6), RM(2,7), and RM(3,7) over binary symmetric channels. Simulation results show that the proposed algorithm outperforms that of the recursive projection-aggregation algorithm by Ye and Abbe, and achieves a near-optimal performance.

In one particular embodiment, a receiver is provided for receiving a signal over a communication channel. The receiver includes a channel estimator, a demodulator, a channel decoder and a source decoder. The channel estimator is configured to receive the signal and estimate channel parameters. The demodulator is configured to demodulate the received signal and estimate transmitted bit sequences based on the channel parameters provided by the channel estimator. The channel decoder is configured to decode the bit sequences received from the demodulator to recover transmitted codewords based on the channel parameters using parallel Monte Carlo Markov Chain (MCMC) decoding. The source decoder is configured to convert the decoded bit sequence output received from the channel decoder into a signal having data that is in a format that is the same as data in the signal transmitted over the communication channel.

In another embodiment, the channel decoder includes a plurality of MCMC decoders operating in parallel, wherein each of the MCMC decoders is configured to produce a candidate codeword estimate.

In yet another embodiment, the channel decoder is further configured to perform a ML decoding process from among the candidate codeword estimates to determine a final codeword estimate.

In another embodiment, each of the MCMC decoders in the plurality of MCMC decoders is a Block Gibbs decoder.

In another embodiment, each of the Block Gibbs decoders is configured to generate a candidate codeword estimate by generating an information set decoding codeword estimate with respect to a randomly sampled generator matrix.

In another embodiment, each of the Block Gibbs decoders is configured to perform MCMC decoding by a process that includes: calculating an information set corresponding to a generator matrix; extracting components of the information set decoding codeword estimate to form a subsequence of the information set decoding codeword estimate; initializing a Markov chain by setting the subsequence as an initial state of the Markov chain; and setting the initial state of the Markov chain as a current best state.

In another embodiment, the generator matrix is in systematic form on the information set.

In another embodiment, each of the MCMC decoders in the plurality of MCMC decoders is a Metropolis-Hastings decoder.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows one example of a communication system that includes a transmitter that communicates with a remotely located receiver over a communication channel.

FIG. 2 is a functional block diagram showing the dataflow of one example of the channel decoder.

FIG. 3 shows a functional block diagram showing the dataflow of one example of the block Gibbs decoders shown in FIG. 2.

FIG. 4 is a flowchart of one example of the MCMC decoding process employed by the block Gibbs decoder shown in FIG. 3.

FIGS. 5(a)-5(d) show the block error rate performance of the parallel block Gibbs decoders described herein for codes RM(2,6), RM(3,6), RM(2,7), and RM(3,7), respectively.

FIGS. 6(a)-6(d) show the block error rates of the parallel block Gibbs decoder versus the number of iterations for codes RM(2,6), RM(3,6), RM(2,7), and RM(3,7), respectively.

### DETAILED DESCRIPTION

Described herein is an MCMC decoding algorithm for linear codes over any type of memoryless channel, including both wired and wireless communication channels. In one aspect, the algorithm constructs multiple Markov chains with different state transition rules using a scheme based on transforming a generator matrix into different systematic forms. The Markov chains operate in parallel and propose the best state from their trajectory as a candidate estimate, and then an ML decoding is performed among the candidates to determine the final estimate.

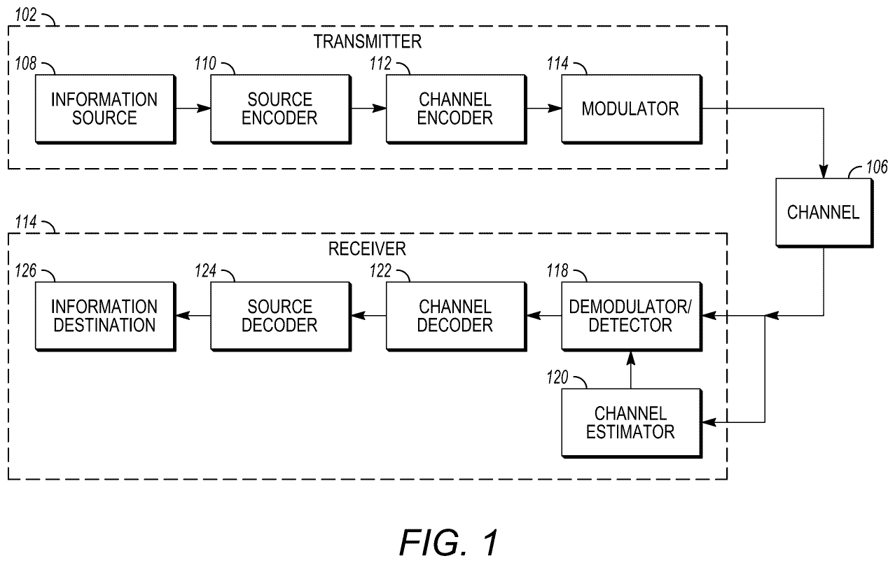

FIG. 1 shows one example of a communication system 100 that includes a transmitter 102 that communicates with a remotely located receiver 104 over a communication channel 106. While for simplicity FIG. 1 shows a system that is arranged for one-way communication, in other implementations the system may be a bidirectional system in which transceivers communicate with one another over a bidirectional communication channel. The transmitter 102 includes an information source 108 that provides the data to be transmitted, a source encoder 110 that encodes the data in the form of symbols, a channel encoder 112 that employs error correction techniques such as forward-error correction, and a modulator 114 for modulating the information as a bit sequence onto a carrier signal so that the resulting modulated signal is transmitted over the communication channel 106.

The receiver 104 receives the modulated signal from the communication channel 106 and a demodulator 118 demodulates the signal to obtain an estimated bit sequence. The receiver 104 also includes a channel estimator 120 that estimates channel parameters corresponding to channel properties of the communication channel 116. The channel parameters may describe how the signal propagates over communication channel 116. The channel parameters represent the combined effect of, for example, scattering, fading and power decay with distance. The channel decoder 122 performs channel decoding to decode the bit sequence to recover the transmitted codewords based on the channel parameters using parallel MCMC decoding as described below. The source decoder 124 converts the decoded bit sequence from the channel decoder to a signal in the same form as the transmitted data and provides it to a desired destination 126.

The decoding performance of the channel decoder described herein is simulated for Reed-Muller (RM) codes of length 64 and 128, including RM(2,6), RM(3,6), RM(2,7), and RM(3,7) over BSCs, and compare to that of the recursive projection-aggregation (RPA) decoder, which is the best previously known algorithm for RM codes. As a randomized algorithm, the MCMC decoder is able to find multiple ML estimates if ties occur, which allows the computation of a tight experimental lower bound on the ML probability of error. Simulation results show that the error rate performance of the new MCMC decoder is almost identical to that of the ML decoder. The tight ML lower bound also shows the existence of a gap between the error probability of the RPA decoder and that of the ML decoder for the RM codes in the simulated regimes.

As used herein, variables are denoted according to the following rules. Vectors are written in bold letters. For a k-dimensional vector v, its i-th component is denoted as vᵢ. If B⊆[k], v_{B} means the subsequence of v comprised by the components whose index is in the set B. The notation ¬B denotes the complement set [k]\B. For i∈ [symbol] , the subscripted bold letter vᵢ means the i-th vector. Finally, parenthesized superscripts are used to denote time indices of a Markov chain.

### Gibbs Decoding of Linear Codes

Let G be a generator matrix of a linear code C of dimension k. The encoding function ε_{G}

$${𝔽}_{2}^{k} \to C$$

is a bijective function that maps each message m∈

$${𝔽}_{2}^{k}$$

to a codeword in C through
the linear operation

ε_{G}(m)=mG. (5)

### Let

$${𝒟}_{G} = {ε}_{G}^{- 1}$$

denote the inverse function of ε_{G}, and let M= [symbol] (X) denote the message corresponding to the codeword X under the encoding of ε_{G}. The Gibbs decoder is an MCMC decoder that generates a sample from the posterior function p(x|Y) by equivalently taking a sample from the posterior p(m|Y)=p( [symbol] (x)|Y) of the message. The Gibbs decoding algorithm is summarized in Algorithm 1, where y is the received bit sequence, x is any initial guess of the transmitted codeword and Tis the maximum number of iterations.

At each iteration the Markov chain replaces a randomly chosen component

$${M}_{i}^{( t - 1 )}$$

of the current state M^{(t-1)} by a new value drawn from the conditional marginal distribution p

$$( {m}_{i} \vert {m}_{¬ \{ i \}} = {M}_{¬ \{ i \}}^{( t - 1 )} , Y )$$

and leaves the other components unchanged. It can be easily shown that the Markov chain

$${\{ {M}^{( t )} \}}_{t = 0}^{∞}$$

Algorithm 1 Gibbs decoding

| | |
|---|---|
| 1: | function GIBBS(Y, x, G, T) |
| 2: | M⁽⁰⁾ ← [symbol] (x) [symbol] Markov chain initialization |
| 3: | for t = 1, 2, . . . , T do [symbol] Main loop |
| 4: | i ← Unif([k]) |
| 5: | ${M}^{( t )} ← p ( m \vert {m}_{¬ \{ i \}} = {M}_{¬ \{ i \}}^{( t - 1 )} , Y )$ |
| 6: | end for |
| 7: | \hat{X}_{Gibbs} < ε_{G}(M^{(T)}) |
| 8: | return \hat{X}_{Gibbs} |
| 9: | end function |

in Algorithm 1 is reversible with respect to the message posterior distribution p(m|Y). Therefore, \hat{X}_{Gibbs}=ε_{G}(M^{(T)}) closely approximates the RL estimate \hat{X}_{RL} if T is large enough.

The slow dynamics are the major drawback of the Gibbs decoder. Many heuristic methods have been proposed to speed up the convergence. Here we briefly introduce the ones that are adopted by our main algorithm.

The first method is the block updates. Instead of replacing one component at a time, the Markov chain randomly picks a block B of b positions and updates the components of the current state in these positions by sampling from the conditional marginal distribution

$${M}_{B}^{( t )} ∼ p ( {m}_{B} \vert {m}_{¬ B} = {M}_{¬ B}^{( t - 1 )} , Y ) . \qquad ( 6 )$$

The method of block updates assumes the feasibility of sampling from this multivariate distribution as long as the block size b is not too large. Note that changing the block size does not affect the reversibility of the Markov chain.

The second method is temperature control. If the stationary distribution of a Markov chain is highly concentrated on a few values (i.e. is highly non-uniform), the chain tends to get stuck in states which are local optima, leading to a prohibitively large mixing time. Temperature control methods counter this by making the Markov chain transitions based on an annealed posterior

p_{α(t)}(m|Y)∝p^{α(t)}(m|Y), (7)

where α(t)∈[0,1] is a parameter, typically referred to as the inverse temperature, which controls the non-uniformity of the distribution. One way of using temperature control is to fix a temperature, i.e. α(t)=α for all t. This approach was used for example in B. Hassibi, M. Hansen, A. G. Dimakis, H. A. J. Alshamary, and W. Xu, “Optimized Markov chain Monte Carlo for signal detection in MIMO systems: An analysis of the stationary distribution and mixing time,” IEEE Trans. Sig. Proc., vol. 62, no. 17, pp. 4436-4450, 2014, where an optimal α was computed and used throughout the MCMC process.

The last method is estimating using the best state discovered by the Markov chain. Let

$$τ ( T ) = {arg max p}_{t ∈ [ T ]} ( {M}^{( t} ) \vert Y ) . \qquad ( 8 )$$

The state M^{(τ(T))} is the one that maximizes the message posterior p(m|Y) along the trajectory of the Markov chain up to time T. Therefore, εG(M^{(τ(T))}) must have a lower probability of error than the vanilla Gibbs decoding estimate \hat{X}_{Gibbs}=εG(M^{(T)}).

Algorithm 2 summarizes the block Gibbs decoding algorithm, which incorporates all the heuristic methods above. In this pseudocode, the function RANDOMSAMPLE(k,b) outputs a randomly selected subset B⊆[k] of size b. This algorithm serves as the fundamental building block of the parallel block Gibbs decoder we propose in the next section.

| Algorithm 2 Block Gibbs decoding | |
|---|---|
| 1: | function BLKGIBBS(Y, x, G, T, α, b) |
| 2: | M⁽⁰⁾ ← [symbol] (x) [symbol] Markov chain initialization |
| 3: | \hat{M}_{BG} ← [symbol] (x) [symbol] Initial estimate |
| 4: | for t = 1, 2, . . . , T do [symbol] Main loop |
| 5: | B ← RANDOMSAMPLE(k, b) |
| 6: | ${M}^{( t )} ← {p}_{α} ( m \vert {m}_{¬ B} = {M}_{¬}^{( t - 1 )} , Y )$ |
| 7: | if p(M^{(t)}\|Y) > p(\hat{M}_{BG}\|Y) then |
| 8: | \hat{M}_{BG} ← M^{(t)} |
| 9: | end if |
| 10: | end for |
| 11: | \hat{X}_{BG} < ε_{G}(\hat{M}_{BG}) |
| 12: | return \hat{X}_{BG} |
| 13: | end function |

### Parallel Block Gibbs Decoder

In an (n,k) linear code, if we have a set of k linearly independent components from a received vector, we can construct the unique codeword that agrees with the component-wise ML values of the received vector at those positions. The set of the indices of these k components is called an information set, and this simple decoding scheme is called information set decoding (ISD), which was first suggested by Prange for decoding cyclic codes in E. Prange, “The use of information sets in decoding cyclic codes,” IRE Transactions on Information Theory, vol. 8, no. 5, pp. 5-9, 1962.

The ISD algorithm has a structure which is compatible with the Gibbs decoder. Let [symbol] ={1, 2, . . . , iₖ} be an information set, where i₁<i₂< . . . <iₖ. We say that a generator matrix G has a systematic form on [symbol] if the k-by-k submatrix of G formed from the columns {i₁, i₂, . . . , iₖ} is equal to the identity matrix.
Example 1: The standard systematic generator matrix of the (7,4) Hamming code has a 4-by-4 identity matrix on the lefthand side

$${G}_{1} = [ \begin{matrix}1 & 0 & 0 & 0 & 0 & 1 & 1 \\ 0 & 1 & 0 & 0 & 1 & 0 & 1 \\ 0 & 0 & 1 & 0 & 1 & 1 & 0 \\ 0 & 0 & 0 & 1 & 1 & 1 & 1\end{matrix} ] . \qquad ( 9 )$$

Therefore, we say that G₁ has a systematic form on the information set [symbol] ={1,2,3,4}. Note that the second, the fourth, the fifth and the sixth columns of G₁ form a basis of the column space, which means that [symbol] ={2,4,5,6} is also an information set. By changing to this new basis using a linear transform, we can obtain

$${G}_{2} = {[ \begin{matrix}0 & 0 & 0 & 1 \\ 1 & 0 & 1 & 0 \\ 0 & 0 & 1 & 1 \\ 0 & 1 & 1 & 1\end{matrix} ]}^{- 1} {G}_{1} = [ \begin{matrix}1 & 1 & 1 & 0 & 0 & 0 & 0 \\ 0 & 0 & 1 & 1 & 0 & 0 & 1 \\ 1 & 0 & 1 & 0 & 1 & 0 & 1 \\ 1 & 0 & 0 & 0 & 0 & 1 & 1\end{matrix} ] , \qquad ( 10 )$$

which is the generator matrix of the (7,4) Hamming code that has a systematic form on [symbol] .

If G has a systematic form on [symbol] , the inverse encoding function [symbol] simply extracts the components of a codeword x from the information set [symbol] :

[symbol]

(x)= [symbol] . (11)

In addition, if Y is the vector of the component-wise ML estimates of the channel output Y, the ISD estimate with respect to [symbol] can be expressed as

\hat{X}_{ISD}(Y, [symbol] )=ε_{G}(Ŷ [symbol] ). (12)

Suppose that we use \hat{X}_{ISD}(Y, [symbol] ) as our initial guess of the transmitted word X and run the block Gibbs decoding algorithm using the systematic generator matrix G. Then,

M⁽⁰⁾= [symbol] (\hat{X}_{ISD}(Y, [symbol] ))= [symbol] (ε_{G}(Ŷ [symbol] ))=Ŷ [symbol] , (13)

will be the initial state of the Markov chain. When the communication channel operates at a regime where the component wise ML estimates are mostly correct, the initialization in (13) guarantees that the Hamming distance between M⁽⁰⁾ and the true message M= [symbol] (X)=X [symbol] would not be large.

Therefore, the Markov chain of the block Gibbs decoder would be more likely to discover the correct message within a few transitions.
Example 2: Consider the communication over a BSC with crossover probability p<0.5 using the (7,4) Hamming code. Suppose that

Y=[1 1 1 1 0 0 0] (14)

is the received sequence. For this case the ML estimate differs from the channel output Y by only one bit at the fourth position

\hat{X}_{ML}(Y)=[1 1 1 0 0 0 0]. (15)

On the other hand, the ISD estimate of Y with respect to the information set [symbol] ={2,4,5,6} in Example 1 is given by

\hat{X}_{ISD}(Y, [symbol] )= [symbol] G₂= [symbol] G₂=[1 1 0 1 0 0 1]. (16)

Note that Y and \hat{X}_{ISD}(Y, [symbol] ) agree at the positions in [symbol] . Using the generator matrix G₂ to construct the Markov chain for the Gibbs decoder means that, at each iteration, the Markov chain will randomly jump to a codeword which agrees with the current state at all but at most one position in [symbol] . Since 4∈ [symbol] , if we initialize the Markov chain with \hat{X}_{ISD}(Y, [symbol] ), there is a positive probability that the Markov chain will find the ML estimate after the first iteration.

As shown in Example 1, a linear code can have multiple information sets. Therefore, it is natural to consider running multiple block Gibbs decoders in parallel to increase the chance of finding the most likely codeword in fewer Markov chain iterations. Given Z distinct information sets [symbol] of a code, we start from an arbitrary generator matrix G and apply elementary row operations to transform G into L different forms G₁, G₂, . . . , G_{L} such that, for [symbol] ∈[L], [symbol] has a systematic form on [symbol] . Then, we run L block Gibbs decoders in parallel. For the [symbol] -th decoder, its Markov chain is constructed based on the generator matrix [symbol] and initialized using [symbol] , the ISD estimate with respect to [symbol] . After sufficiently many iterations, each block Gibbs decoder proposes a candidate according to Algorithm 2. Finally, we perform an ML decoding among the candidates to determine the final estimate. This parallel block Gibbs decoding algorithm is summarized in Algorithm 3, where the COMPML function outputs the component-wise ML estimates of the given bit sequence y.

We note that, for some special linear codes, taking the ML codeword over a bunch of ISD estimates is equivalent to the ML decoding. The simplest example is the repetition code. If we are given more than

$$⌈ \frac{N + 1}{2} ⌉$$

ISD estimates from distinct information sets, then at least one of them will equal to the ML estimate. However, for most linear codes, analyzing the performance of this ML-among-ISD-estimate method is a

Algorithm 3 Parallel block Gibbs decoding

1: function PARBLKGIBBS(y, G₁, . . . , G_{L}, [symbol] , . . . , [symbol] , T, α, b)
2: ŷ ← COMPML(y) [symbol] Component-wise ML
3: for [symbol] = 1,2, . . . , L do in parallel
4: [symbol] [symbol] Initial guess
5: [symbol] ← BLKGIBBS(y, [symbol] , T, α, b)
6: end for
7: [symbol] ← [symbol] ( [symbol] |Y)
8: \hat{X}_{PBG} ← [symbol]
9: return \hat{X}_{PBG}
10: end function

difficult problem. The block Gibbs decoding steps in Algorithm 3 can be regarded as a postprocessing procedure that decreases the decoding error probability of the ISD.

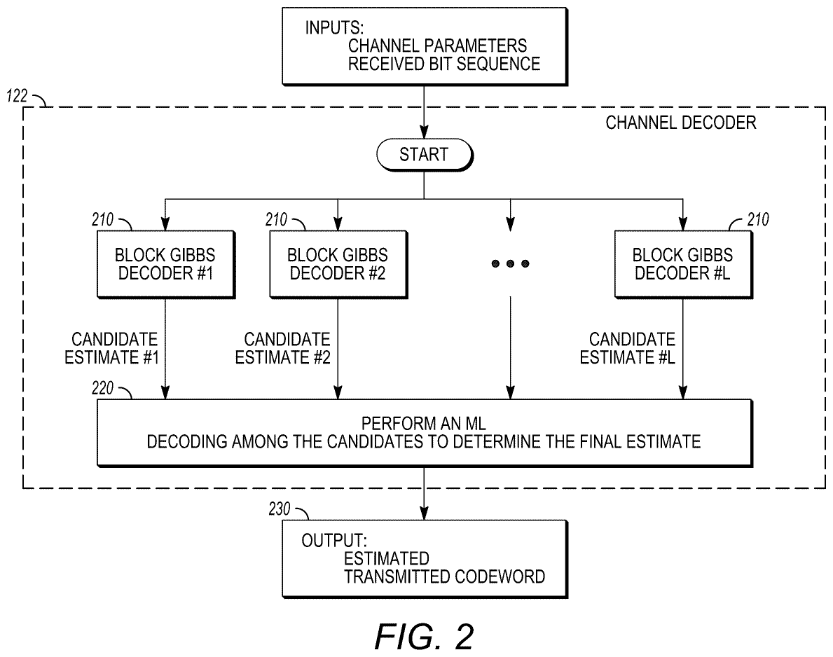

FIG. 2 is a functional block diagram showing the dataflow of one example of the channel decoder 122. The channel decoder 122 includes a plurality of block Gibbs decoders 210 that receive as inputs the channel parameters and the bit sequence. More generally, however, any suitable MCMC decoder may be employed, such as a Metropolis-Hasting decoder, for example. Each of the block Gibbs decoders 210 produces a candidate codeword estimate. An ML decoding process 220 is performed among the candidate codeword estimates to produce the final codeword estimate 230, which is provided as the output from the channel decoder 122.

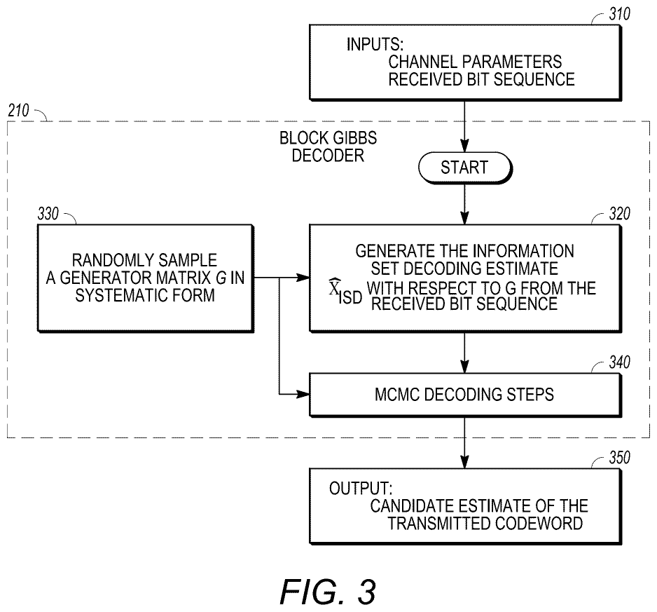

FIG. 3 shows a functional block diagram showing the dataflow of one example of the block Gibbs decoders 210 shown in FIG. 2. As shown, the block Gibbs decoder 210 receives at block 310 the channel parameters and the bit sequence and produces as an output 350 a candidate codeword estimate by generating at block 320 an information set decoding codeword estimate with respect to a generator matrix in systematic form that is randomly sampled at block 330. The generator matrix can be sampled in real-time or it can be pre-sampled and stored in the channel decoder.

In one implementation, the information set decoding codeword estimate is generated through the following steps. (see Example 2):
1. Find the columns of the generator matrix such that the submatrix formed by the columns is an identity matrix. (The set of the positions of these columns is called the information set of the generator matrix.)
2. Extract the components of the received bit sequence whose position is in the information set.
3. Collect the components extracted in Step 2 to form a subsequence.
4. Left multiply the subsequence by the generator matrix to obtain the information set decoding estimate.

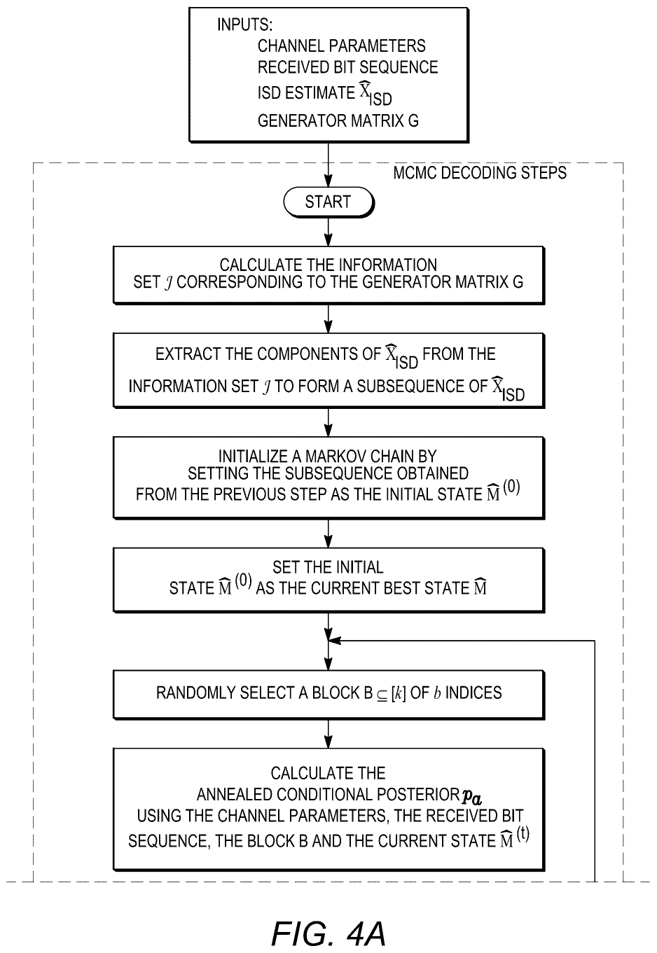

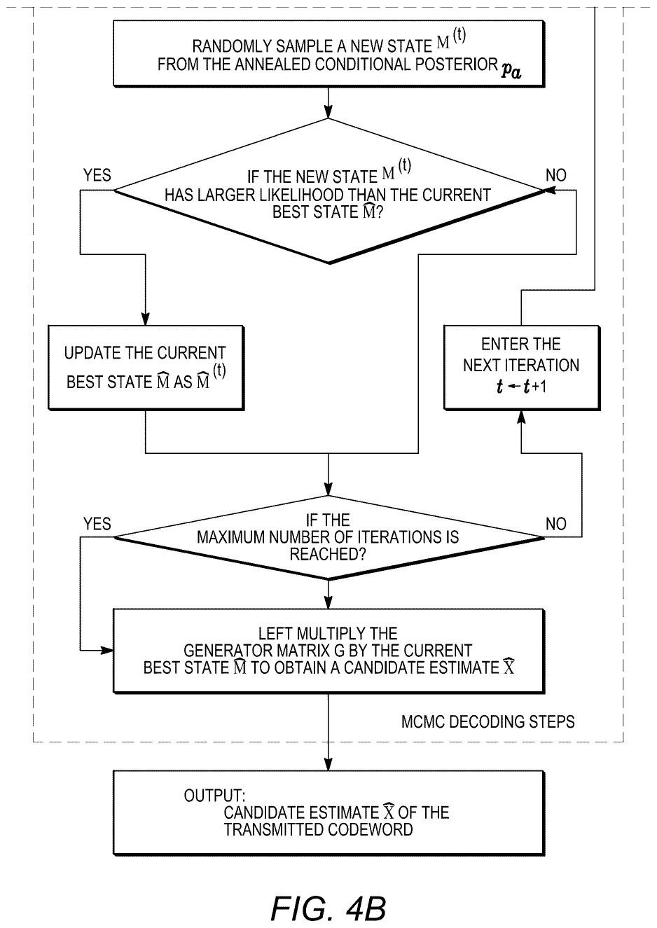

As further shown in FIG. 3, after the information set decoding codeword estimate is generated, an MCMC decoding process is then performed at block 340 using the randomly sampled generator matrix and the information set decoding codeword estimate. Details concerning one example of the MCMC decoding process are shown in the flowchart of FIG. 4.

In FIG. 4, the information set calculation follows step 1 above for generating the information set decoding codeword estimate in FIG. 3. Also in FIG. 4, the annealed conditional posterior is calculated through the following iterative steps.
1. for each sequence M′ that agrees with the current state M^{(t)} on the positions in block B do
1.1 calculate its likelihood
1.2 power the likelihood by α
2. normalize each likelihood value by the sum of all values.

The calculation of the likelihood in step 1.1. requires knowledge of the received bit sequence and the channel parameters. For example, in the case of an additive white Gaussian noise (AWGN) channel, the likelihood is evaluated from a Gaussian distribution whose variance is determined by the channel parameter signal-to-noise ratio (SNR).

### Simulation Results

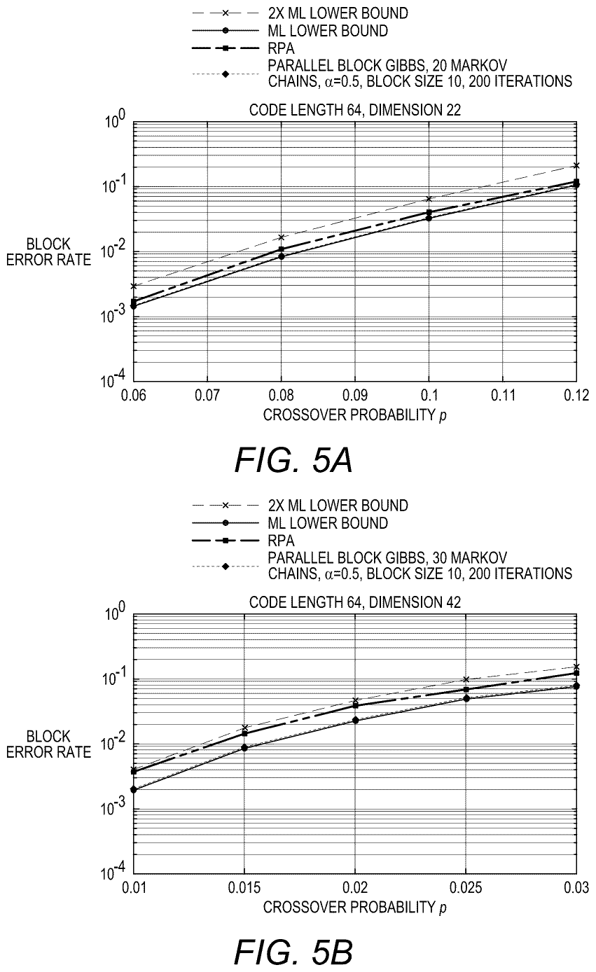

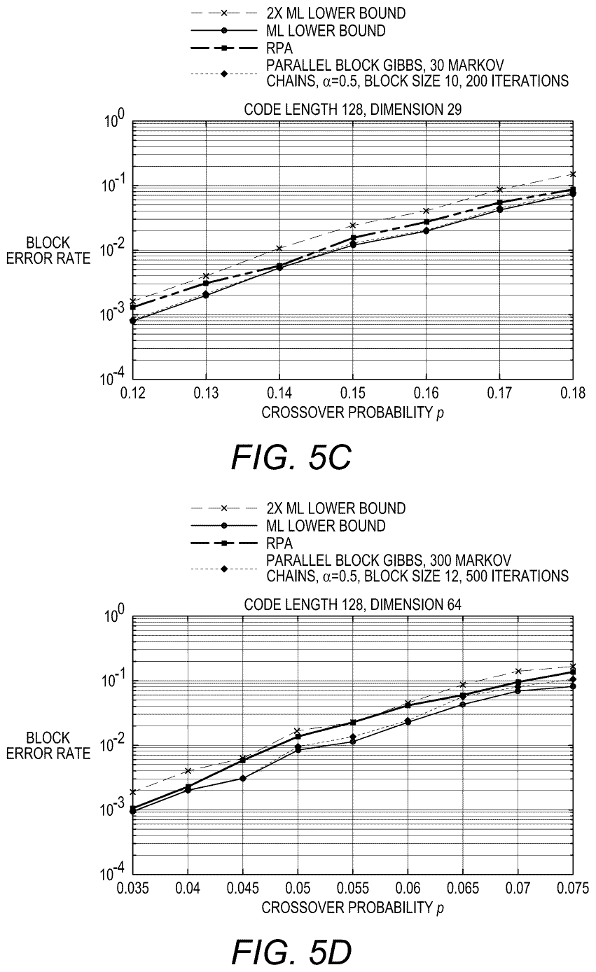

We simulate the block error rates of the parallel block Gibbs decoder for RM codes of length 64 and 128, including RM(2,6), RM(3,6), RM(2,7) and RM(3,7), over BSCs with various crossover probabilities. For each RM code, we randomly generate distinct information sets and use them to construct the Markov chains. The simulation results are presented in FIGS. 5(a)-5(d). The black solid lines, termed the “ML lower bound” are obtained as follows. Given a realization of the output sequence y, we compare the posterior probability of the decoded codeword \hat{X}_{PBG} and that of the transmitted codeword X. If p(\hat{X}_{PBG}|Y=y)>p(X|Y=y), then the optimal ML decoder would surely misdecode y as well. If a tie occurs p(\hat{X}_{PBG}|Y=y)=p(X|Y=y), we count the number N of distinct codewords in the set {X, \hat{X}₁, . . . , XL} that have the same posterior probability as X. For this case the ML decoder would misdecode y with probability no less than:

$$1 - \frac{1}{N} .$$

The black line in each plot records the empirical average of these probabilities, and is thus a lower bound on the error probability of the ML decoder.

Simulation results show that the parallel block Gibbs decoder can achieve or nearly achieve the ML lower bound. We also plot the performance of the RPA decoder without list decoding for comparison. Our simulation results show that the block error rate of the RPA decoder is less than twice of the ML decoding error probability. Nevertheless, the RPA decoder does not achieve the ML lower bound in general.

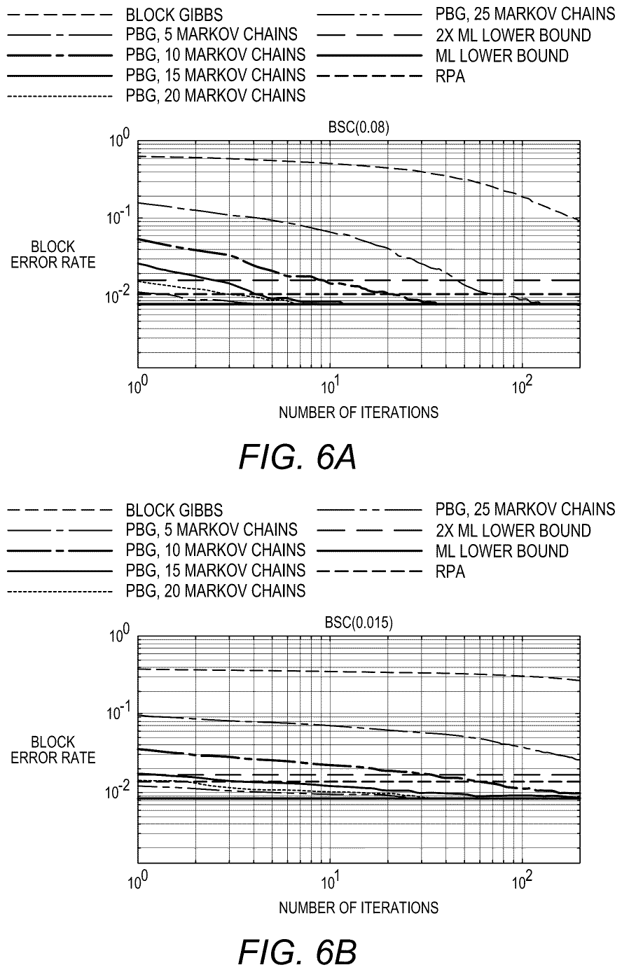

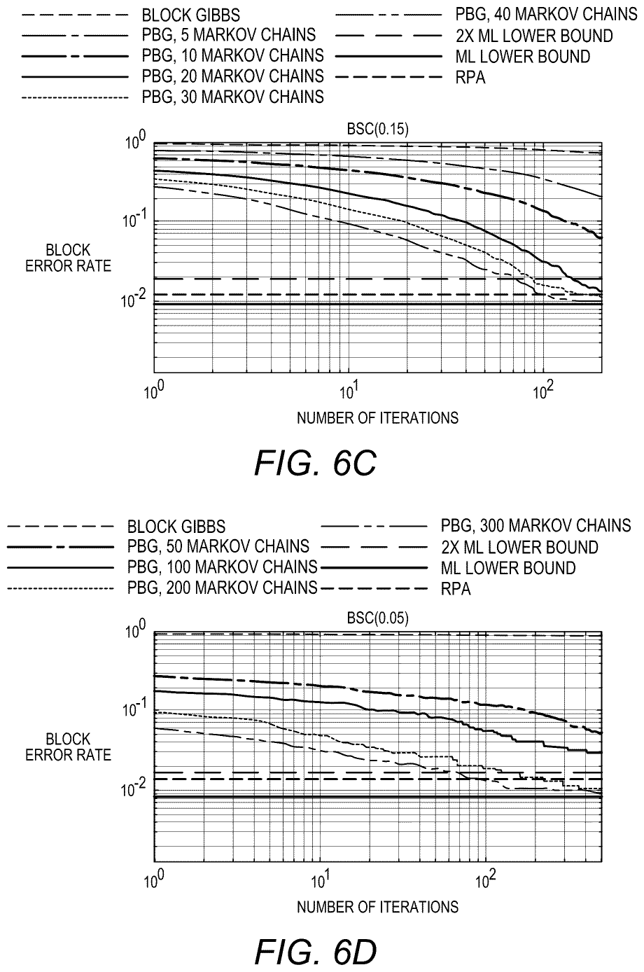

FIGS. 6(a)-6(d) shows how the block error rate of the parallel block Gibbs decoder changes with the number of iterations as well as the number of Markov chains used in the algorithm. We present the results where the ML lower bound is around the level of 0.01. For RM(2,6), RM(3,6) and RM(2,7), the parallel block Gibbs decoder can achieve the ML block error rate within 200 iterations using no more than 40 Markov chains. For RM(3,7), about 300 Markov chains are required for the parallel block Gibbs decoder to reach the ML lower bound in 500 iterations.

In summary, a parallel block Gibbs MCMC decoding algorithm has been described herein for decoding linear codes. Numerical experiments have demonstrated that, for short Reed-Muller codes, the error probability of the proposed decoder is close to the optimal value achieved by the ML decoding. The near-optimality of the parallel MCMC decoder is, however, not code-specific. In fact, we have also observed similar results for short blocklength LDPC codes.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). However, computer readable storage media do not include transitory forms of storage such as propagating signals, for example. Of course, those skilled in the art will recognize many modifications may be made to this configuration without departing from the scope or spirit of the claimed subject matter.

Some of the elements described in the disclosed embodiments may be implemented as modules that define an isolatable element that performs a defined function and has a defined interface to other elements. The blocks described in this disclosure may be implemented as modules in hardware, a combination of hardware and software, firmware, or a combination thereof. For example, modules may be implemented using computer hardware in combination with software routine(s) written in a computer language (MATLAB, Java, HTML, XML, PHP, Python, ActionScript, JavaScript, Ruby, Prolog, SQL, VBScript, Visual Basic, Perl, C, C++, Objective-C or the like). Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs), field programmable gate arrays (FPGAs), and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

In addition, it should be understood that any figures that highlight any functionality and/or advantages, are presented for example purposes only. The disclosed architecture is sufficiently flexible and configurable, such that it may be utilized in ways other than that shown. For example, instructions listed in any block may be re-ordered, combined with other instructions, or only optionally used in some embodiments.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein but may be modified within the scope and equivalent of the appended claims.

1. A receiver for receiving a signal over a communication channel, comprising:
a channel estimator configured to receive the signal and estimate channel parameters;
a demodulator configured to demodulate the received signal and estimate transmitted bit sequences based on the channel parameters provided by the channel estimator;
a channel decoder configured to decode the bit sequences received from the demodulator to recover transmitted codewords based on the channel parameters using parallel Monte Carlo Markov Chain (MCMC) decoding;
a source decoder configured to convert the decoded bit sequence output received from the channel decoder into a signal having data that is in a format that is the same as data in the signal transmitted over the communication channel.

2. The receiver of claim 1, wherein the channel decoder includes a plurality of MCMC decoders operating in parallel, wherein each of the MCMC decoders is configured to produce a candidate codeword estimate.

3. The receiver of claim 2, wherein the channel decoder is further configured to perform a ML decoding process from among the candidate codeword estimates to determine a final codeword estimate.

4. The receiver of claim 2, wherein each of the MCMC decoders in the plurality of MCMC decoders is a Block Gibbs decoder.

5. The receiver of claim 4, wherein each of the Block Gibbs decoders is configured to generate a candidate codeword estimate by generating an information set decoding codeword estimate with respect to a randomly sampled generator matrix.

6. The receiver of claim 5, wherein each of the Block Gibbs decoders is configured to perform MCMC decoding by a process that includes: calculating an information set corresponding to a generator matrix; extracting components of the information set decoding codeword estimate to form a subsequence of the information set decoding codeword estimate; initializing a Markov chain by setting the subsequence as an initial state of the Markov chain; and setting the initial state of the Markov chain as a current best state.

7. The receiver of claim 6, wherein the generator matrix is in systematic form on the information set.

8. The receiver of claim 1, herein each of the MCMC decoders in the plurality of MCMC decoders is a Metropolis-Hastings decoder.

9. A method for receiving a signal over a communication channel, comprising:
receiving the signal and estimate channel parameters;
demodulating the received signal and estimating transmitted bit sequences based on the channel parameters provided by the channel estimator;
decoding the bit sequences received from the demodulator to recover the transmitted codewords based on the channel parameters using parallel Monte Carlo Markov Chain (MCMC) decoding;
converting the decoded bit sequence output received from the channel decoder into a signal that has data in a format that is the same as data in the signal transmitted over the communication channel.

10. The method of claim 9, further comprising producing a candidate codeword estimate using the MCMC decoding operating in parallel

11. The method of claim 10, further comprising a ML decoding process from among the candidate codeword estimates to determine a final codeword estimate.

12. The method of claim 10, wherein the MCMC decoding is performed by a plurality of Block Gibbs decoders.

13. The method of claim 12, generating a candidate codeword estimate by generating an information set decoding codeword estimate with respect to a randomly sampled generator matrix.

14. The method of claim 13, further comprising performing the MCMC decoding by a process that includes: calculating an information set corresponding to a generator matrix; extracting components of the information set decoding codeword estimate to form a subsequence of the information set decoding codeword estimate; initializing a Markov chain by setting the subsequence as an initial state of the Markov chain; and setting the initial state of the Markov chain as a current best state.

15. The method of claim 14, wherein the generator matrix is in systematic form on the information set.

16. The method of claim 9, wherein the MCMC decoding is performed by a plurality of Metropolis-Hastings decoders.
